(19) United States
(12) Patent Application Publication
(10) Pub. No.: US 2009/0227916 A1
(43) Pub. Date: Sep. 10, 2009

(54) Method for treating muscular tendonous hypertonicity

(76) Inventor: Arik Warren Gohl, Tacoma, WA (US)

Correspondence Address: Arik W. Gohl, 6608 S. Monroe St., Tacoma, WA, 98409, US

(21) Appl. No.: 12/007,905

(22) Filed: Jan. 17, 2008

(51) Int. Cl. A61H 7/00

(52) U.S. Cl. 601/134

(57) ABSTRACT

A method of manual therapy used in the correction of musculo-skeletal dysfunction in the fields of medicine, athletics, and entertainment that uses ligamentous tissue to influence musculo-tendonous hypertonicity, correction of numerous muscular and skeletal pathologies can be made. The method uses the influence of light tactile pressure to ligament receptors to regulate and reprogram muscular stiffness much in the same way activity in primary muscle spindle afferents, modify muscle tonicity The steps are as follows: location of e the symptomatic anatomy, targeted muscle or muscles are shortened to relax muscle-spindle fibers, application of light to mild static tactile engagement of the corresponding ligament found by use of pre-determined referral patterns then held for 15-30 seconds or until the muscle tissue has released it's tension, muscle lengthening and re-assessment. The last two steps are repeated until 80-95% reduction in abnormal muscle tension trigger-points is met.

### BACKGROUND OF THE INVENTION

1. Field of the Invention

This invention relates generally to message or manual manipulative therapy and more particularly methods for reducing hypertonicity of muscle-tendon bundles.

2. Description of the Related Art

In the field of manual therapies practiced by massage therapists, osteopaths, physical therapists, and chiropractors, there are several methods of correcting musculoskeletal problems. These methods include muscle energy technique, deep-tissue muscle work, skeletal manipulation, trigger-point therapy, passive positional release, and neuromuscular therapy. Although these are widely agreed upon to be established and effective therapies, recipients often do not experience reduced symptoms for extended periods of time, nor do their existing pathologies seem to become corrected without extended care and sometimes even with extended care or surgery. I have found from over 13,000 hours of utilizing and teaching these modalities, reviewing case studies, and as well as from interviewing numerous manual therapists, that the previous statement is accurate. Due to the widely accepted notion that ligaments are in place only to support joint structures of the skeletal system, and have little effect on the proprioceptive sensory systems, there has not been any known effort made to use them in order to correct pathologies. Instead current methods such as those named above focus on treating musculo-tendonous and bone tissues. The one exception is a technique called “Logan Basic.” Developed by a chiropractor by the name of Dr. Hugh Logan in the early part of the twentieth century, this technique consists of applying gentle static pressure to the sacro-tuberous ligaments of the lower spine. This gentle pressure produces a relaxation effect on some of the para-spinal muscles located at the back. Although a reliable tool for chiropractors, there has not been any further research in applying similar methods to other ligaments in order to produce like outcomes with different muscle groups.

In the development and application of Gohl Ligamentous Release, it has been found that by addressing the ligament tissues of the body, the foundational reasons for musculo-skeletal dysfunctions are often corrected. Treating ligament tissue is seldom done in current manual therapies except in the case of reducing scar tissue on ligaments caused by tearing. Called cross-fiber friction, this is performed by vigorously rubbing the scarred portion of the ligament to break down the fibrotic tissues. Dr. Moshe Solomonow a PhD at the University of Colorado, has been conducting experiments with ligaments for the past 25 years and has concluded in numerous published case studies that ligaments are often the propagating factor in musculo-skeletal pain and dysfunction and is due to repeated loading and unloading of ligaments without proper rest. Unlike muscles which require only 6-8 hours of recovery time after repetitive loading and unloading, ligaments require several times that amount and without proper rest, will develop micro-tears inducing inflammation which in turn affects muscle tone in an attempt to stabilize a joint. Scientific research shows that ligaments are sensory organs and do in fact significantly influence muscle tension and function. With this evidence at hand, the logic behind the unique and potent effects of Gohl Ligamentous Release is strongly supported.

### SUMMARY OF THE INVENTION

One object of the invention is to induce correction for musculo-skeletal dysfunctions through the application of therapies to the ligaments of the body.

Another object is to deliver long lasting and even permanent relief to pathologies affecting the quality of physical health and fitness.

A further object of the invention is to increase the performance of participants in such fields as athletics, dance, manual labor, martial arts, and music.

A still further objective of the invention is to have affects on the pathologies of the internal organs of the body as they are supported by ligaments and may be subject to the same corrective properties as with the musculo-ligament system.

According to the present invention, the foregoing and other objects are met by influencing ligamentous tissue in a way that sends information to the associated muscles and tendons facilitating a release of tension, reduction of trigger-points, and re-alignment of tissues thereby assisting in the correction of dysfunction.

More particularly, the method uses the influence of light tactile pressure to ligament receptors to regulate and reprogram muscular stiffness much in the same way activity in primary muscle spindle afferents, modify muscle tonicity The steps are as follows: location of e the symptomatic anatomy, targeted muscle or muscles are shortened to relax muscle-spindle fibers, application of light to mild static tactile engagement of the corresponding ligament found by use of pre-determined referral patterns then held for 15-30 seconds or until the muscle tissue has released it's tension, muscle lengthening and re-assessment. The last two steps are repeated until 80-95% reduction in abnormal muscle tension trigger-points is met.

### DESCRIPTION OF THE DRAWINGS

FIG. 1 is an illustration showing a hand performing an ulnar collateral ligament release.

FIG. 2 is an illustration of a shoulder showing the relative locations of the scapula, clavical, humerous and the attaching ligaments.

FIG. 3 is an illustration showing a hand performing a coracoclavicular collateral ligament release.

FIG. 4 is an illustration showing a hand performing a sacroiliac ligament release.

FIG. 5 is an illustration showing a hand performing a lateral collateral ligament release.

FIG. 6 is an illustration showing a hand performing a spring ligament release.

FIG. 7 is an illustration showing a hand performing a medial collateral ligament release.

FIG. 8 is an illustration showing a hand performing a deltoid ligament release.

FIGS. 9 and 10 is a Release Table

### DESCRIPTION OF THE PREFERRED EMBODIMENT(S)

Referring to the accompanying Figs. there is shown a method for treating hypertonicity of various muscles by applying light tactile pressure to muscle's ligament receptors The method includes primarily the following steps: locating the symptomatic anatomy, targeted muscle or muscles are shortened to relax muscle-spindle fibers, apply light to mild static tactile engagement of the corresponding ligament found by use of pre-determined referral patterns then held for 15-30 seconds or until the muscle tissue has released it's tension, muscle lengthening and re-assessment, repeating the last two steps 80-95% reduction in abnormal muscle tension trigger-points is met.

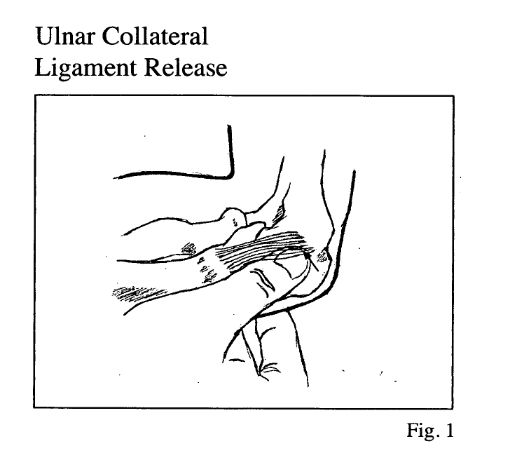

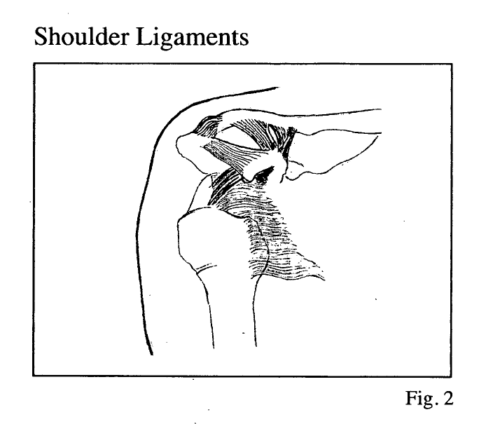

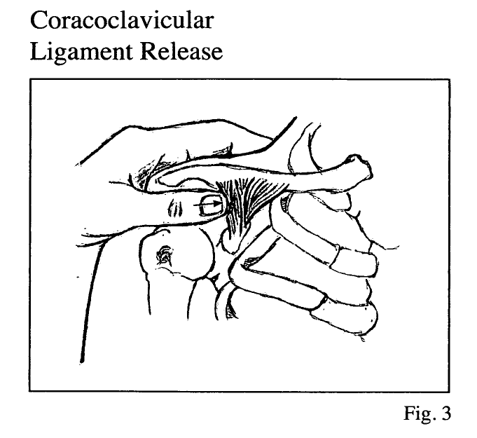

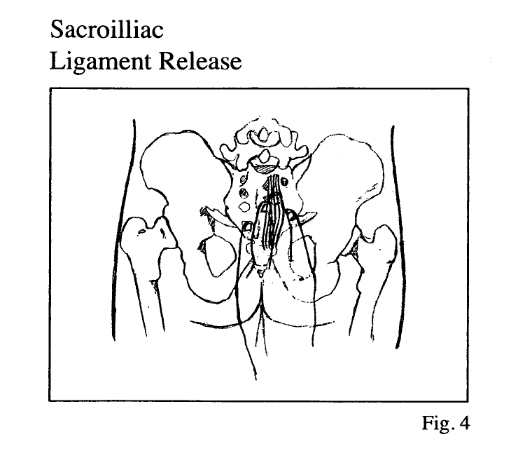

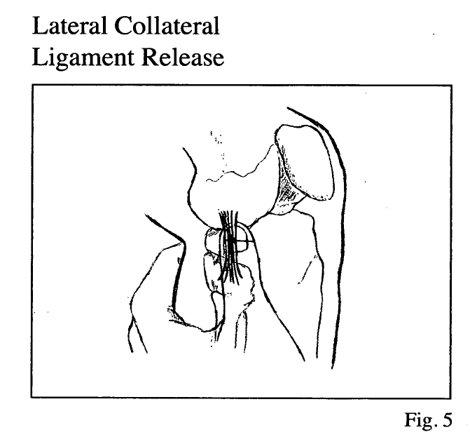

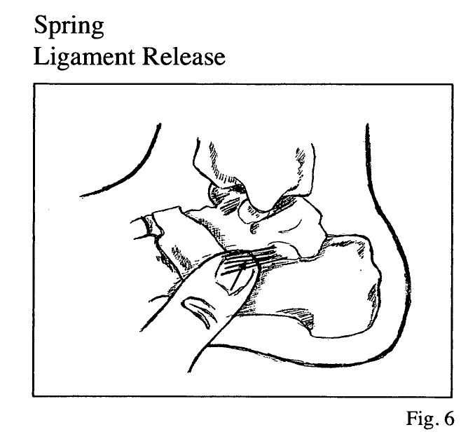

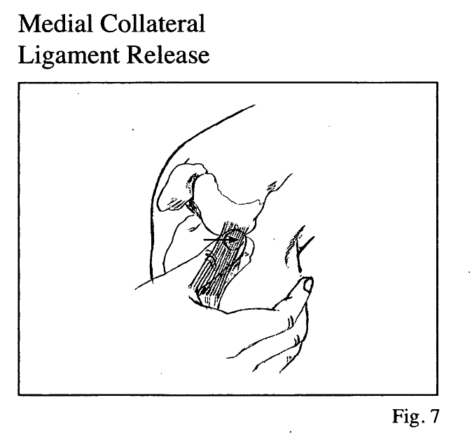

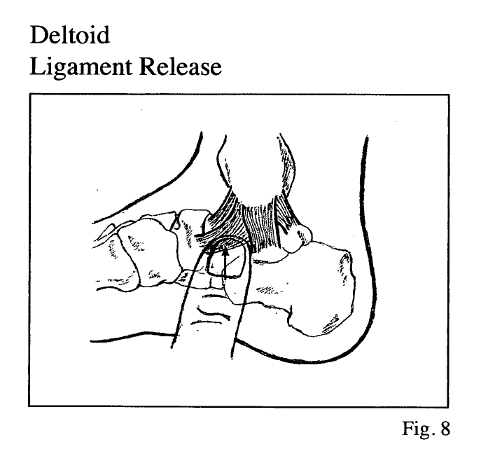

Shown in the Figs are different illustrations showing a hand applying the method to different parts of the body. For example, FIG. 1 is an illustration showing a hand performing an ulnar collateral ligament release. FIG. 2 is an illustration of a shoulder showing the relative locations of the scapula, clavical, humerous and the attaching ligaments. FIG. 3 is an illustration showing a hand performing a coracoclavicular collateral ligament release. FIG. 4 is an illustration showing a hand performing a sacroiliac ligament release. FIG. 5 is an illustration showing a hand performing a lateral collateral ligament release. FIG. 6 is an illustration showing a hand performing a spring ligament release. FIG. 7 is an illustration showing a hand performing a medial collateral ligament release. FIG. 8 is an illustration showing a hand performing a deltoid ligament release.

In each application of the method, the practitioner first palpates and or tests the muscle groups and limb to assess for hypertonicity and reduction of movement. This can be done by assessing muscle tonicity, trigger and tender points, and with passive/active/resistive range of motion testing.

Next, after locating the muscle or muscles in a hypertonic state, the limb is positioned in a manner that shortens (as much as possible) the muscle or muscles needing to be affected by GLR. The ligament that has been found to provide the most influence to said muscle is located by use of pre-determined referral patterns as present in the Release Table shown in FIGS. 9 and 10.

Next, light to mild static pressure of 3-4 pounds per square inch is applied to the ligament usually in a cross-fiber direction for 15-30 seconds. The practitioner can then move along the ligament to locate areas of tension to then re-apply pressure to continue the release effect on the muscle. Either fingertips or a solid device can be used to engage the ligament. (See FIGS. 1-5)

Next, the muscle is lengthened to palpate for tenderness and or hyopertonicity. Active, passive, and resistive range of motion testing can also be used again as well.

The muscle is then released which should result in a 80-95% reduction in tension, tenderness, and dysfunction. If this is not the case, the process should be repeated. Note: If a release of 80-95% is not seen within 2-3 attempts, check to verify ligaments were properly located, if that is the case, other pathologies involving the central nervous system may be involved and GLR should not be attempted again with that muscle until further testing has been carried out.

In compliance with the statute, the invention described herein has been described in language more or less specific as to structural features. It should be understood however, that the invention is not limited to the specific features shown, since the means and construction shown, is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. A method for reducing the hypertonicity of a muscular-tendonous bundle, comprising the following steps:
a. identify the muscle-tendonous bundle under hypertonicity;
b. moving the joint to shorten the muscle tendonous bundle;
c. applying manipulative pressure to the ligament that connects to said muscle-tendonous bundle for 15 to 30 seconds or until the hypertonicity condition of said muscle tendonous bundle is reduced;
d. lengthened the muscle-tendonous bundle; and,
e. determining if the muscle-tendonous bundle is still under hypertonicity, and repeating steps c thru d until hypertonicity is reduced.
